(19) United States
(12) Patent Application Publication
(10) Pub. No.: US 2021/0245663 A1
(43) Pub. Date: Aug. 12, 2021

(54) MOTORCYCLE SIDE-VIEW MIRROR

(71) Applicants: Joe Hirst, Gates, NC (US); Edythe Hirst, Gates, NC (US)

(72) Inventors: Joe Hirst, Gates, NC (US); Edythe Hirst, Gates, NC (US)

(21) Appl. No.: 16/784,216

(22) Filed: Feb. 6, 2020

(51) Int. Cl. B60R 1/08; B60R 1/00; B62J 29/00

(52) U.S. Cl. CPC B60R 1/088; B60R 1/06; B62J 29/00; B60R 1/006

(57) ABSTRACT

A side-view mirrors for a motorcycle is presented. The side-view mirrors have a sensor for dimming the side-view mirrors for motorcycles. The sensor has a computer and a sensing field. The computer receives signaling from the sensing field and computes a result. When the amount of light has exceeded a threshold, a signal is sent to a communicatively coupled mirror to dim the mirrors to provide safety for the motorcyclist.

### FIELD OF THE INVENTION

This invention relates to motorcycles. More particularly, it relates to motorcycle side-view mirrors.

### BACKGROUND

A motorcycle, often called a bike, motorbike, or cycle, is a two- or three-wheeled motor vehicle. Motorcycle design varies greatly to suit a range of different purposes: long distance travel, commuting, cruising, sport including racing, and off-road riding. Motorcycling is riding a motorcycle and related social activity such as joining a motorcycle club and attending motorcycle rallies.

A side-view mirror (or rearview mirror) is a Convex mirror in automobiles and other vehicles, designed to allow the driver to see rearward to the vehicle's rear.

Depending on the type of motorcycle, the motorcycle may or may not have side-view mirrors. Street-legal motorcycles are generally required to have side-view mirrors. Motorcycles for off-road use only normally do not have side-view mirrors. Side-view mirrors come in various shapes and designs, and have various methods of mounting the mirrors to the motorcycle, most commonly to the handlebars. Side-view mirrors can also be attached to the rider's motorcycle helmet.

Side-view mirrors reflect light that is shining at night. When the light being reflected is from a car or other vehicle, the reflection of the light may be too bright and cause a driver of the motorcycle to be temporarily blinded or have an obstructed view. Therefore, there is a need for a device that can overcome at least the problem so mentioned.

### BRIEF DESCRIPTION OF THE DRAWINGS

FIG. 1 is an illustrated view of a motorcycle handle bar with exemplary side-view mirrors.

FIG. 2 is an illustrated detailed view of the exemplary side-view mirrors shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

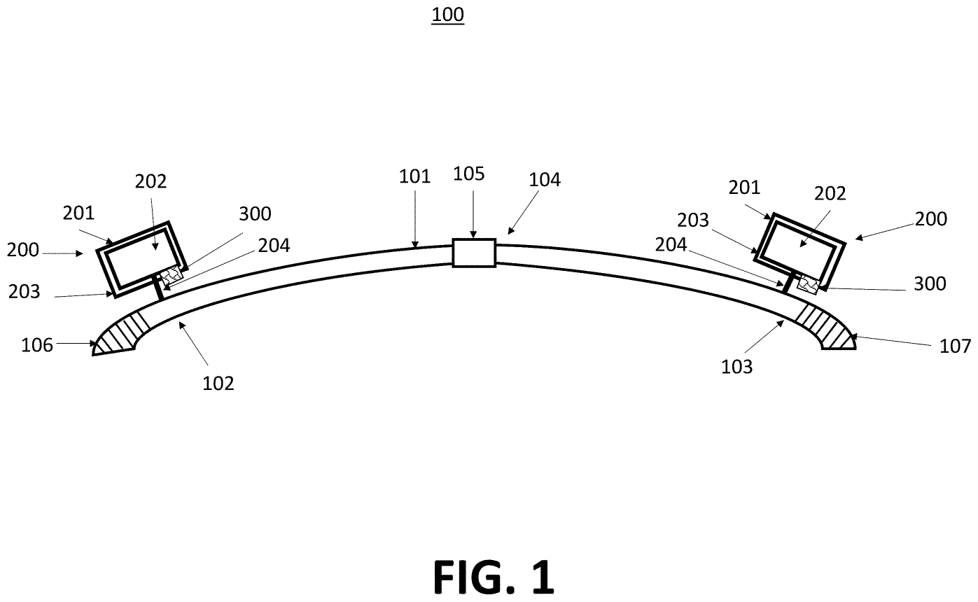

Referring to FIG. 1, an illustrated view of a motorcycle handle-bar 100 with exemplary side-view mirrors 200 for automatically dimming light reflected from the side-view mirrors 200. The motorcycle handle-bar 100 with the exemplary side-view mirrors 200 is useful for dimming the side-view mirrors for motorcycles.

The motorcycle handle-bar 100 has a bar 101, a first end 102, a second end 103, a middle portion 104 and a coupler 105. The bar 101 is preferably made of a metal material, such as steel, aluminum, etc., but other materials are hereby contemplated including, but not limited to, hard-plastic, poly-vinyl chloride (PVC), etc.

The first end 102 of the bar 101 of the motor cycle handle-bar 100 has a first grip 106. The first grip 106 of the first end 102 of the bar 101 of the motor cycle handle-bar 100 is preferably made of a rubber material, but other materials are hereby contemplated including, but not limited to, leather, plastic, etc.

The second end 103 of the bar 101 of the motor cycle handle-bar 100 has a second grip 107. The second grip 107 of the second end 103 of the bar 101 of the motor cycle handle-bar 100 is preferably made of a rubber material, but other materials are hereby contemplated including, but not limited to, leather, plastic, etc.

The second grip 107 of the second end 103 of the bar 101 of the motor cycle handle-bar 100 is preferably made of the same material as the first grip 106 of the first end 102 of the bar 101 of the motor cycle handle-bar 100, but it is hereby contemplated that the second grip 107 of the second end 103 of the bar 101 of the motor cycle handle-bar 100 is made of the different material as the first grip 106 of the first end 102 of the bar 101 of the motor cycle handle-bar 100.

A first of the two mirrors 200 is coupled to substantially near the first end 102 of the bar 101 of the motorcycle handle-bar 100. The second of the two mirrors 200 is coupled to substantially near the second end 103 of the bar 101 of the motorcycle handle-bar 100.

The mirrors 200 have a housing 201. The housing 201 of the mirrors 200 is preferably made of a chrome material, but other materials are hereby contemplated including, but not limited to, hard plastic, poly-vinyl chloride (PVC), etc.

The housing 201 has a mirror 202 and a bottom edge 203. The mirror 202 is reflective of items behind the rear of the motorcycle, thereby allowing the driver of the motorcycle to have a view of items, such as cars, coming up from behind the motorcycle. The housing 201 of the mirror 200 is securely and movably coupled to the first end 102 and the second end 103 of the bar 101 of the motorcycle handle-bar 100 by a pole 204. The pole 204 is preferably made of a hard-plastic material, but other materials are hereby contemplated including, but not limited to, chrome, steel, aluminum, etc.

A sensor 300 is coupled to the bottom edge 203 of the housing 201 of the mirrors 200. The sensor 300 is preferably an optical sensor but other sensors are hereby contemplated including, but not limited to, proximity sensor, temperature sensor, etc. The sensor 300 is useful to detect the amount of light being received, the proximity of another vehicle, etc.

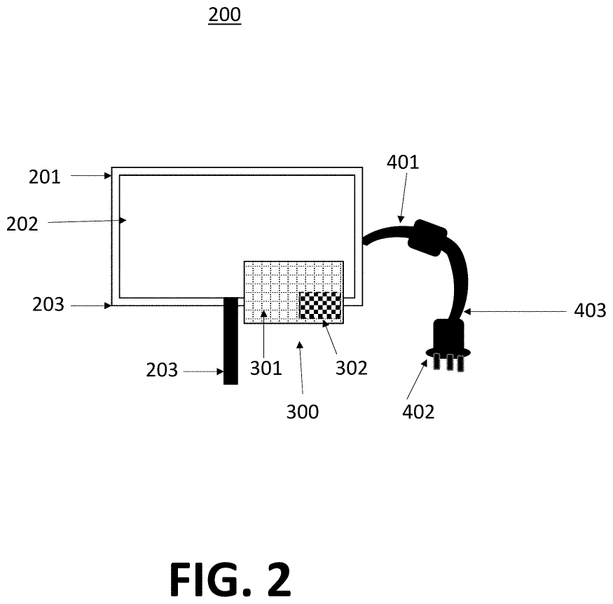

Moving now to FIG. 2, an illustrated detailed view of the exemplary side-view mirrors 200 shown in FIG. 1.

The mirrors 200 have a housing 201. The housing 201 of the mirrors 200 is preferably made of a chrome material, but other materials are hereby contemplated including, but not limited to, hard plastic, poly-vinyl chloride (PVC), etc.

The housing 201 has a mirror 202 and a bottom edge 203. The mirror 202 is reflective of items behind the rear of the motorcycle, thereby allowing the driver of the motorcycle to have a view of items, such as cars, coming up from behind the motorcycle. The housing 201 of the mirror 200 is securely and movably coupled to the first end 102 and the second end 103 of the bar 101 of the motorcycle handle-bar 100 by a pole 204. The pole 204 is preferably made of a hard-plastic material, but other materials are hereby contemplated including, but not limited to, chrome, steel, aluminum, etc.

A sensor 300 is coupled to the bottom edge 203 of the housing 201 of the mirrors 200. The sensor 300 is preferably an optical sensor but other sensors are hereby contemplated including, but not limited to, proximity sensor, temperature sensor, etc. The sensor 300 is useful to detect the amount of light being received, the proximity of another vehicle, etc.

The sensor 300 has a sensing field 301. The sensing field 301 senses the amount of light, proximity of an object such as a vehicle, etc. The sensor 300 has a computer 302 internally coupled to the sensing field 301.

The computer 302 computes signaling received from the sensing field 301 and computes the amount of light being received, the proximity of another vehicle, etc. The computer 302 is preferably a chip which runs software or firmware to compute the results from the signals received from the sensing field 301. The computer 301 is communicatively coupled to the mirrors 200. When a threshold is reached, the computer 302 signals the mirrors 200 to dim, thus reducing glare and brightness from the lights of a vehicle behind the motorcycle.

The mirrors 200 are coupled to a power source (not shown). The power source is preferably a motorcycle battery, but other types of power sources are hereby contemplated including, but not limited to, solar, wind, Nicad battery, etc.

An electrical cable 401 is communicatively coupled to the mirrors 200. The electrical cable 401 has a electrical connector 402 coupled to a distal end 403 of the electrical cable 401. The electrical connector 402 is preferably a battery coupler, but other types of connectors are hereby contemplated including, but not limited to, ac/dc plug, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A motorcycle side-view mirror device for detecting amount of light from a light source, the device comprising:
a mirror, the mirror for viewing behind the rear of a motorcycle, wherein the mirror comprising:
a housing;
a mirror, the mirror being on an interior portion of the housing;
a sensor, the sensor coupled to a bottom edge of the housing, and wherein the sensor further comprising:
a sensing field, the sensing field being for detecting the light of the light source;
a computer, the computer communicatively coupled to the mirror and wherein the computer being communicatively coupled to the sensor field; and
wherein the computer receives signals from the sensor field, wherein the computer determines a result from the signals from the sensor field; and
when the result exceeds a threshold, the computer sending a signal to the mirror wherein the mirror dims.

2. The device of claim 1, wherein the mirror further comprising:
An electrical cable, the electrical cable communicative coupled to the mirror and the electrical cable being communicatively coupled to the computer; and
Wherein the electrical cable has a electrical connector for connecting to a power source.

3. The device of claim 3, wherein the power source being a motorcycle battery.

4. The device of claim 1, wherein the sensor being an optical sensor.

5. The device of claim 1, wherein the mirror being coupled to a first end of a handle-bar.

6. The device of claim 1, wherein the mirror being coupled a second end of a handle-bar.

7. The device of claim 1, wherein the mirror being adjustable for the amount of light detected by the sensing field.
